(19) United States
(12) Patent Application Publication
(10) Pub. No.: US 2001/0040766 A1
(43) Pub. Date: Nov. 15, 2001

(54) Head slider and disk drive

(76) Inventor: Michio Yotsuya, Kanagawa (JP)

Correspondence Address: FROMMER LAWRENCE & HAUG, 745 FIFTH AVENUE- 10TH FL., NEW YORK, NY, 10151, US

(21) Appl. No.: 09/730,298

(22) Filed: Dec. 5, 2000

(30) Foreign Application Priority Data
Dec. 6, 1999 (JP) P11-346813

(51) Int. Cl. G11B 5/60

(52) U.S. Cl. 360/236.1

(57) ABSTRACT

To provide a disk drive with a head slider which is capable of suppressing scratching of a head slider and a recording medium when the head slider and the surface of the recording medium contact each other due to vibration or shock. And a head slider is also capable of inhibiting entry of foreign matter such as dirt and dust between a magnetic disk surface and an air bearing surface of the head slider and thereby suppressing a reduction of the fly height of the head slider and destabilization of the floating action. A head slider is provided with a rail formed on a facing surface arranged facing a moving recording medium surface and having a air bearing surface projected from the facing surface receiving a lifting force from the air flow between the recording medium surface and the facing surface 16, wherein contour of the rail at the side facing the air flow is curve convex with respect to the air flow.

### BACKGROUND OF THE INVENTION

1. Field of the Invention

The present invention relates to a head slider applied to a disk drive, for example, a magnetic disk drive, an optical disk drive, and a magneto-optic disk drive, for recording and/or reproduction of information by rotating a disk-like recording medium, carrying a head for recording and/or reproduction of the information, and floating above a moving recording medium surface and to a disk drive provided with this head slider.

2. Description of the Related Art

In a magnetic disk drive referred to as a hard disk drive (HDD), in order to avoid an abrasion and scratches due to a contact between the surface of the magnetic disk (information recording and/or reproducing surface) and a magnetic head serving as the electromagnetic transduction element for the recording and/or reproduction of information with the magnetic disk, generally the magnetic head is mounted on a head slider floating from the surface of the rotating magnetic disk and records and/or reproduces the information without contact.

The surface of the head slider facing the magnetic disk is formed with a rail receiving a flying pressure from the air flow generated when rotating the magnetic disk. The magnetic head flies together with the slider above the magnetic disk surface with a fine fly height. The fly height in the disks being loaded in magnetic disk drives currently on the market is for example about 0.04 μm. At the research level, a fly height of 0.02 μm has already been realized.

From the viewpoint of the electromagnetic transformation action, the clearance formed by the head slider flying from the magnetic disk surface is preferably as small as possible in order to realize high density recording since it causes spacing loss.

In order to reduce this clearance, in the design of a head slider, it is necessary to reduce the fly height and secure a stable fly height and to make the surface of the magnetic disk a smooth one with a roughness less than the fly height so as to prevent the head slider from contacting the magnetic disk surface.

Accordingly, in order to reduce the fly height of the head slider, it is necessary to make the surface of the magnetic disk smoother.

On the other hand, many magnetic disk drives of the related art have employed the so-called “contact start-stop” (CSS) system of allowing the head slider to contact the surface of the magnetic disk when starting or stopping the rotation of the magnetic disk.

In this method, when the hard disk drive is at rest, the head slider contacts a certain area (generally an innermost circumference) of the magnetic disk. Along with startup, the head slider starts flying due to the air flow generated by the rotation of the magnetic disk and stably flies when the magnetic disk stabilizes at steady rotation.

In such a CSS system magnetic disk drive, sometimes the air bearing surface of the head slider sticks to the surface of the magnetic disk due to long contact between the head slider and the magnetic disk. It is therefore necessary to deliberately make the surface of the magnetic disk rough in order to prevent this sticking phenomenon.

As explained above, however, in order to reduce the fly height of the head slider with respect to the magnetic disk surface, it is necessary to make the magnetic disk surface as smooth as possible. Therefore, in a CSS system magnetic disk drive, further reduction of the fly height is difficult.

Recently, in order to reduce the fly height, a method of dynamically loading/unloading the head slider with respect to the magnetic disk has been proposed. This system is similar to the automatic loading/unloading system of a record player and makes a suspension mounting the head slider ascend or descend along a ramp provided at the outside of the magnetic disk so as to unload or load the head slider with respect to the magnetic disk.

In this method, cost is incurred for incorporating a precision loading/unloading mechanism in the drive, but since a magnetic disk having a very smooth surface can be used, the fly height of the head slider can be reduced. Therefore, this system is now becoming the mainstream of magnetic disk drives.

Summarizing the problems to be solved by the invention, a magnetic disk drive employing the loading/unloading system suffers from the disadvantage that the magnetic disk is sometimes scratched due to contact between the head slider and the magnetic disk when for example shock is imparted to the drive at the time of loading/unloading the head slider. Namely, a rail etc. are formed on the air bearing surface of the head slider. When the edges of the rail or the like contact the magnetic disk, the magnetic disk is sometimes scratched. If the magnetic disk is scratched, there is a possibility of loss of the data of that portion.

Further, when the contact between the magnetic disk and the head slider is vigorous, the head slider may also be scratched resulting in flying becoming impossible and the drive itself breaking down.

Further, along with the recent spread of laptop type or palm type personal computers, there is an increasing likelihood of the magnetic disk drives built in personal computers being subjected to various types of vibration or shock. For this reason, even magnetic disk drives of the loading/unloading system or the CSS system may encounter the problem of the magnetic disk and the head slider crashing each other.

On the other hand, in magnetic disk drives of the related art, in addition to the problem of the magnetic disk and the head slider striking each other as described above, there is the problem of the entry of dirt or dust between the magnetic disk surface and the air bearing surface of the head slider and the resultant reduction of the fly height of the head slider and destabilization of the flying action.

In particular, in a so-called removable system magnetic disk drive where the magnetic disk is accommodated in a cartridge and this cartridge is inserted into and ejected from the magnetic disk drive, at the time of insertion or ejection of the cartridge, the drive is opened to the outside, so entry of dirt or dust into the drive easily occurs and the dirt and dust entering between the magnetic disk surface and the air bearing surface of the head slider again invite a reduction of the flying height of the head slider and destabilization of the flying action.

### SUMMARY OF THE INVENTION

An object of the present invention is to provide a head slider capable of suppressing scratching of the head slider and the recording medium when the head slider contacts the surface of the recording medium due to vibration or shock and capable of suppressing a reduction of the fly height of the head slider and the destabilization of the flying height action by inhibiting entry of foreign matter such as dirt and dust between the magnetic disk surface and the air bearing surface of the head slider.

Another object of the present invention is to provide a disk drive provided with this head slider.

According to a first aspect of the present invention, there is provided a head slider comprising a slider having a rail formed on a facing surface arranged facing a rotating recording medium surface and receiving a lifting force from an air flow between said recording medium surface and said facing surface, and a head performing at least one of reproduction and recording of data, wherein the contour of said rail at the side facing said air flow is a curve convex with respect to said air flow.

According to a second aspect of the present invention, there is provided a head slider comprising a slider having a rail formed on a facing surface arranges facing a rotating recording medium surface and receiving a lifting force from an air flow between said recording medium surface and said facing surface, and a head performing at least one of reproduction and recording of data, wherein the contour of said slider at the side facing said air flow is a curve convex with respect to said air flow.

According to a third aspect of the present invention, there is provided a disk drive provided with a disk drive comprising a rotation means for rotating a disk-like recording medium, a slider having a rail formed on a facing surface arranged facing the rotating recording medium surface and receiving a lifting force from air flow between said recording medium surface and said facing surface, and a head mounted in said slider and performing at least one of reproduction and recording of data, wherein the contour of said rail at the side facing said air flow is curve convex with respect to said air flow.

According to a fourth aspect of the present invention, there is provided a disk drive provided with a disk drive comprising a rotation means for rotating a disk-like recording medium, a slider having a rail formed on a facing surface arranged facing the rotating recording medium surface and receiving a lifting force from air flow between said recording medium surface and said facing surface and a head mounted in said slider and performing at least one of reproduction and recording data, wherein the contour of said slider at the side facing said air flow is a curve convex with respect to said air flow.

In the present invention, by comprising the contours of the rail or the head slider by curves, the contact pressure is held low even in the case where the head slider contacts the surface of the recording medium.

Further, since the contour of the rail is comprised by curves, a side face of the portion facing the air flow in the rail projected from the facing surface of the head slider forms a curved surface curved convex with respect to the air flow.

Accordingly, dirt, dust, and other bodies with mass heading between the air bearing surface of the rail and the surface of the recording medium more easily head to the sides of the rail due to the action of the convexly curved surface and thus are inhibited from entering between the air bearing surface and the surface of the recording medium.

### BRIEF DESCRIPTION OF THE DRAWINGS

These and other objects and features of the present invention will become clear from the following description of the preferred embodiments given with reference to the accompanying drawings, wherein:

FIG. 1 is a perspective view of an example of a disk drive to which the present invention is applied;

FIG. 2 is a view of a state where a head slider is flying above a magnetic disk surface;

FIG. 3 is a perspective view of the configuration of a facing surface of a head slider according to a first embodiment of the present invention;

FIG. 4 is a plan view of the facing surface of the head slider shown in FIG. 3;

FIG. 5 is a view of a simulation of the path of flow of dirt and dust when forming rails projected from the facing surface of the head slider and making the contours of portions facing a direction of air flow F at the peripheries of the rails elliptical;

FIG. 6 is a view of a simulation of the path of flow of dirt and dust when forming rails projected from the facing surface of the head slider and making the contours of portions facing the direction of air flow F at the peripheries of the rails elliptical shapes with different orientations of their long axes;

FIG. 7 is a view of a simulation of the path of flow of dirt and dust when forming rails projected from the facing surface of the head slider and making the contours of portions facing the direction of air flow F at the peripheries of these rail arcs;

FIG. 8 is a view of a simulation of the path of flow of dirt and dust when forming rails projected from the facing surface of the head slider and making the contours of portions facing the direction of air flow F at the peripheries of the rails straight;

FIG. 9 is a view of a simulation of the path of flow of dirt and dust to the facing surface 16 of the head slider 15 shown in FIG. 3 and FIG. 4;

FIG. 10 is a view of a simulation of the path of dirt and dust to the facing surface 116 of the head slider shown in FIG. 18 and FIG. 19;

FIG. 11 is a view of a modification of the head slider 15 according to the first embodiment of the present invention;

FIG. 12 is a view of another modification of the head slider 15 according to the first embodiment of the present invention;

FIG. 13 is a view of still another modification of the head slider 15 according to the first embodiment of the present invention;

FIG. 14 is a view of the configuration of the facing surface of a head slider according to a second embodiment of the present invention;

FIG. 15 is a view of the configuration of the facing surface of a head slider according to a third embodiment of the present invention;

FIG. 16 is a view of a modification of the head slider according to the third embodiment of the present invention;

FIG. 17 is a perspective view of an example of a removable type magnetic disk drive;

FIG. 18 is a perspective view of an example of the configuration of the facing surface of a head slider; and

FIG. 19 is a plan view of the facing surface of the head slider of FIG. 18.

### DESCRIPTION OF THE PREFERRED EMBODIMENTS

Below, embodiments of the present invention will be explained by referring to drawings.

### First Embodiment

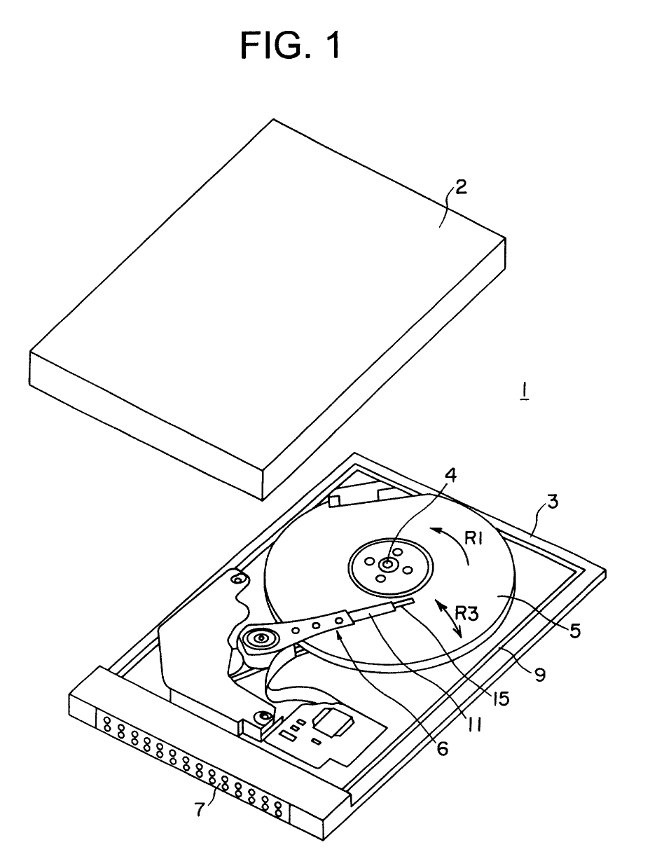

FIG. 1 is a perspective view of an example of a disk drive using a head slider of the present invention. The disk drive shown in FIG. 1 is for example a card type magnetic disk drive built into a computer.

The magnetic disk drive 1 shown in FIG. 1 is provided with a chassis 3, a top cover 2 for covering the chassis 3, a spindle motor 4 arranged on the chassis 3, a magnetic disk 5 serving as the recording medium rotated by the spindle motor 4, an actuator 6 arranged on the chassis 3, a suspension 11 connected to this actuator 6, and a head slider 15 held at a front end of this suspension 11 and mounting the magnetic head.

The magnetic disk 5 is fixed to the spindle motor 4. The magnetic disk 5 rotates at a predetermined rotation speed, for example, about 2700 rpm, by the drive of the spindle motor 4.

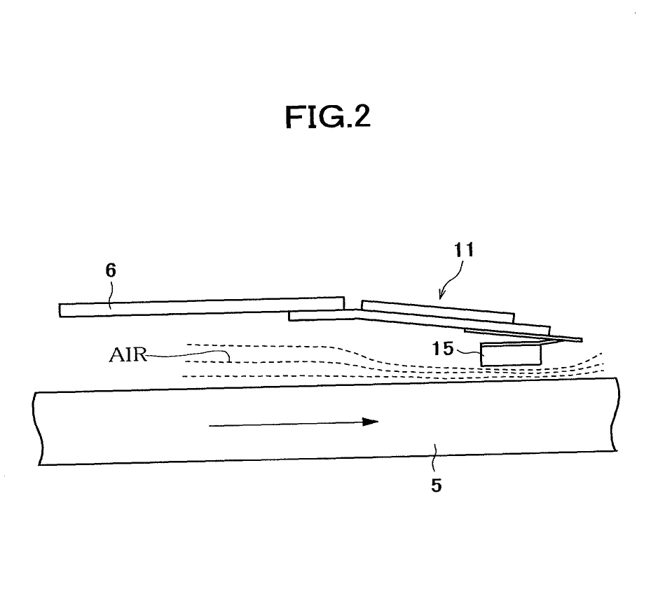

The head slider 15 arranged facing the surface of the rotating magnetic disk 5, as shown in FIG. 2, flies with respect to the surface of the magnetic disk 5 by the air flow generated due to the movement of the magnetic disk 5. The fly height of the head slider 15 is adjusted to a constant value by a balance between lifting force received from the air flow and a pressing force from the suspension 11, but for example is about 20 nm. Further, the pressing load of the suspension 11 is for example about 3 gf.

On the other hand, the actuator 6 pivots in a direction indicated by an arrow R3. The head slider 15 held at the front end of the actuator 6 moves in substantially a radial direction of the magnetic disk 5. By positioning the magnetic head mounted on the head slider 15 with respect to the desired track of the magnetic disk 5, the magnetic head can record information to the magnetic disk 5 and reproduce information recorded on the magnetic disk 5.

### Configuration of Head Slider

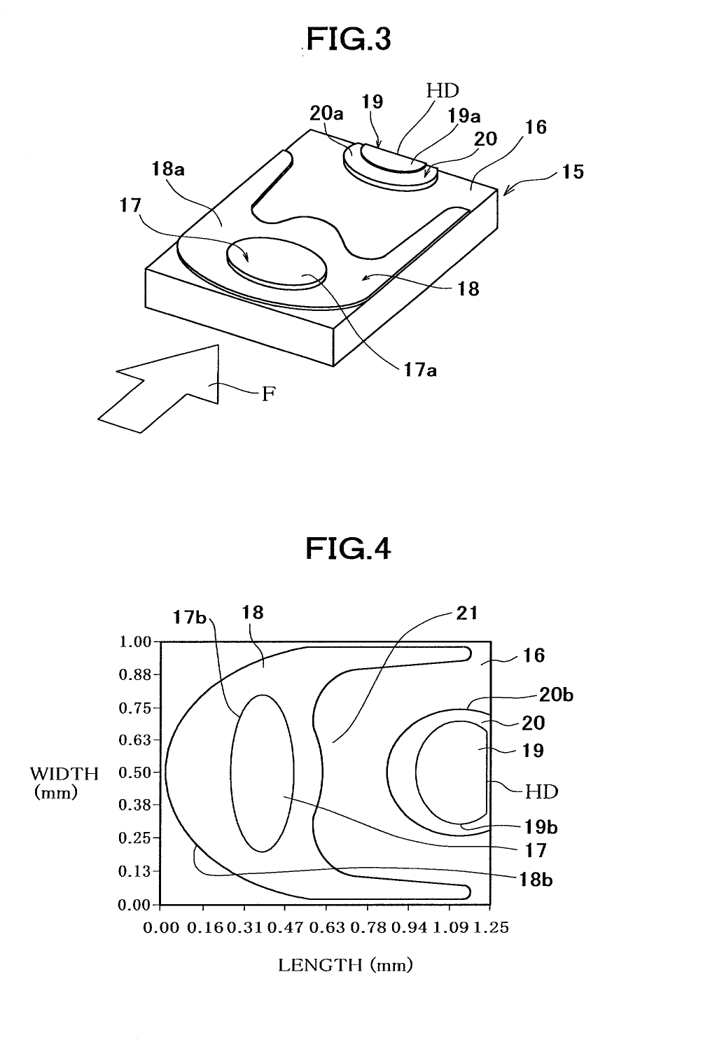

FIG. 3 is a perspective view of the configuration of a facing surface side of the head slider according to an embodiment of the present invention facing the magnetic disk 5, while FIG. 4 is a plan view of the facing surface side of the head slider shown in FIG. 3. Note that, in FIG. 4, the dimensions of the head slider 15 are also shown.

In FIG. 3, an arrow F indicates the direction of air flow. The head slider 15 has a rectangular facing surface 16 facing the magnetic disk 5. At the inflowing end side of the air flow of this facing surface 16 is formed a rail 17 having a air bearing surface 17a receiving a lifting force from the air flow between the surface of the magnetic disk 15 and the facing surface 16.

The air bearing surface 17a of the rail 17 projects out from the facing surface 16. The depth from the air bearing surface 17a to the facing surface 16 is for example several tens of μm.

Further, as shown in FIG. 4, the contour of periphery 17b of the rail 17 is completely curved. Specifically, the contour forms an ellipse having a long axis in a direction perpendicular to the direction of flow F.

A step 18 formed contiguous with the circumference of the rail 17 and projected from the facing surface 16 and having an air bearing surface 18a located between the air bearing surface 17a and the facing surface 16 is formed.

The step 18 is formed to a shape symmetrical about a center line of the head slider 15 along the direction of flow F. The depth of the air bearing surface 18a of the step 18 from the air bearing surface 17a of the rail 17 is for example about 3 μm.

This air bearing surface 18a of the step 18, similar to the rail 17, receives a lifting force from the air flow between the surface of the magnetic disk 15 and the facing surface 16.

The contour of the side of the periphery 18b of the step 18 facing the direction of flow F is curved. Specifically, it is configured by part of an ellipse convex with respect to the direction of flow F.

Further, the two sides of the trailing end of the step 18 extend toward the trailing end of the head slider 15 along the direction of flow F.

A negative pressure cavity 21 is formed in the concave portion formed by the shape of the down-streaming side of this step 18.

A negative pressure having a saction force the head slider 15 approach the surface of the magnetic disk 5 is generated in this negative pressure cavity 21 by the air flow from the direction of flow F.

The negative pressure generated in this negative pressure cavity 21 acts so as to prevent the facing surface 16 of the head slider 15 from flying from the surface of the magnetic disk 5 more than necessary. Due to this, a suitable fly height of the head slider 15 is attained.

At the trailing side of the air flow of the facing surface 16 of the head slider 15 is formed a rail 19 having an air flow surface 19a with the same height as that of the rail 17. A step 20 having an air bearing surface 20a with the same height as that of the step 18 is formed at the outer circumference of this rail 19. Further, a magnetic head HD is mounted at the approximate center position on the trailing end of the head slider 15.

The air bearing surfaces 19a and 20a of the rail 19 and the step 20, similar to the rail 17, receive a lifting force for making the slider 15 lift from the surface of the magnetic disk 5.

The contours of portions facing the flow F at the peripheries 19b and 20b of the rail 19 and step 20 form curves. Specifically, they are comprised by parts of ellipses.

It will be understood that, in the head slider 15 having the above configuration, the contours of portions facing the flow F at the peripheries 17b and 19b of the rail 17 and 19 and the peripheries 18b and 20b of the step 18 and 20 projected from the facing surface 16 are comprised by curves convex with respect to the direction of flow F.

Here, an explanation will be given of the mode of operation by making the contours of the peripheries 17b, 19b, 18b, and 20b of the rails 17 and 19 and the steps 18 and 20 projected from the facing surface 16 curved.

When all of the peripheries 17b, 19b, 18b, and 20b of the rails 17 and 19 and the steps 18 and 20 are made straight, edge portions are formed at the peripheries 17b, 19b, 18b, and 20b of the rails 17 and 19 and the steps 18 and 20. These edge portions contact the surface of the magnetic disk 5 when the head slider 15 contacts the surface of the magnetic disk 5 and sometimes scratch the surface of the magnetic disk 5 or the head slider.

By making the contours of the periphery 17b, 19b, 18b, and 20b of the rails 17 and 19 and the steps 18 and 20 curved as in the present embodiment, there are no longer edge portions scratching the surface of the magnetic disk 5 when the head slider 15 contacts the surface of the magnetic disk 5 at the peripheries 17b, 19b, 18b, and 20b and thus scratching of the surface of the magnetic disk 5 can be suppressed.

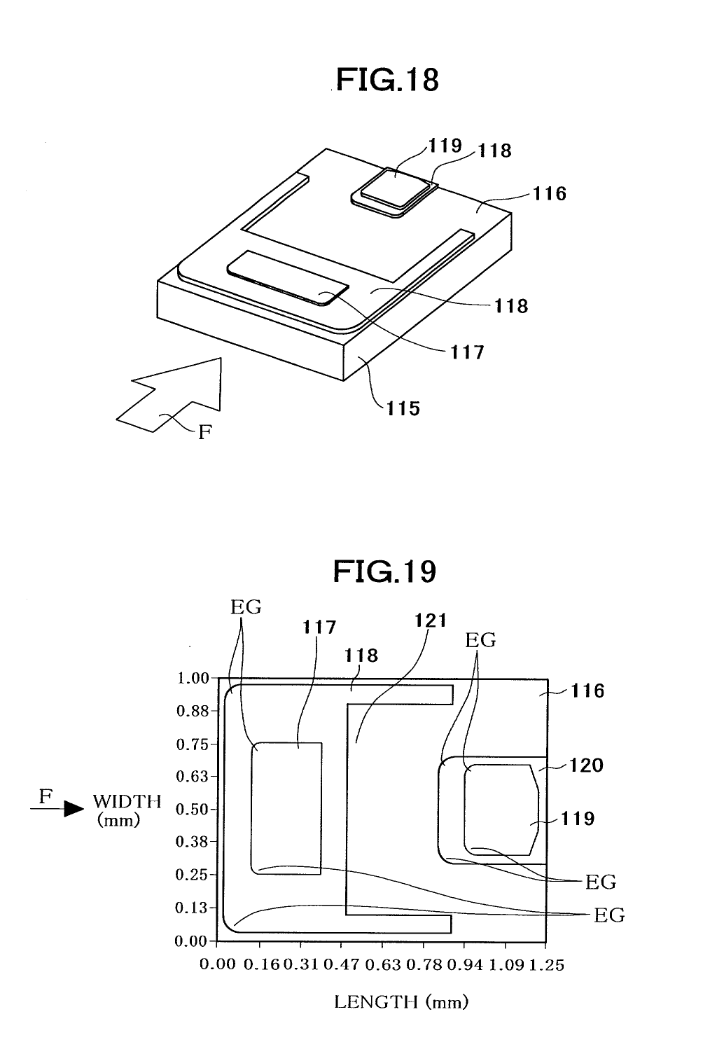

Note that even when configuring the rails and the steps of the head slider as shown in for example FIG. 18 and FIG. 19, scratching of the surface of the magnetic disk 5 or the head slider due to contact between the head slider and the magnetic disk surface can be suppressed. Note that FIG. 18 is a perspective view of another configuration of the facing surface of the head slider capable of suppressing scratching of the surface of the magnetic disk 5 due to contact between the head slider and the magnetic disk surface, while FIG. 19 is a plan view of the facing surface of the head slider shown in FIG. 18.

A facing surface 116 of a head slider 115 shown in FIG. 18 is provided with rails 117 and 119 and steps 118 and 120 similar to the head slider 15 according to the present embodiment. The peripheries of these rails 117 and 119 and steps 118 and 120 are basically straight. Further, a negative pressure cavity 121 is formed at the trailing end side of the step 118 along the direction of flow F.

Further, edges EG of the rails 117 and 119 and the steps 118 and 120 are rounded.

By forming the edges EG of the rails 117 and 119 and the steps 118 and 120 as smooth curves in this way, there is no longer any sharply pointed portions on the facing surface 116 side of the head slider 115, a contact pressure becomes low even if a rounded edge EG contact the surface of the magnetic disk 5 due to contact between the head slider and the magnetic disk surface, and therefore the surface of the magnetic disk 5 is prevented from being scratched.

As described above, even if the contours of the peripheries 17b, 19b, 18b, and 20b of the rails 17 and 19 and the steps 18 and 20 are not all curved and even if only the edge portions are comprised by smooth curves, scratching due to the contact between the head slider and the magnetic disk surface can be suppressed.

The head slider 15 of the present embodiment exhibits, in addition to such an action, an action of suppressing entry of dirt, dust, a lubricant, or the like between the surface of the rotating magnetic disk 5 and the air bearing surfaces 17a, 19a, 18a, and 20a of the rails 17 and 19 and the steps 18 and 20 of the head slider 15 by making the contours of the peripheries 17b, 19b, 18b, and 20b of the rails 17 and 19 and the steps 18 and 20 facing the flow F curves convex to the flow F.

Dirt and dust enters into the magnetic disk drive from the outside or are generated due to contact between the head slider 15 and the surface of the magnetic disk 5. If the dirt and dust enter between the surface of the magnetic disk 5 and the air bearing surfaces 17a, 19a, 18a, and 20a and deposit on the air bearing surfaces 17a, 19a, 18a and 20a, the fly height of the head slider 15 becomes unstable or the fly height becomes insufficient. Further, usually a liquid lubricant is coated on the surface of the magnetic disk 5 in order to reduce contact force between the head slider 15 and the magnetic disk 5. If this lubricant deposits on their bearing surfaces 17a, 19a, 18a, and 20a of the head slider 15, the fly height of the head slider 15 will be unstable or the fly height will be lowered.

The head slider 15 of the present embodiment acts so as to suppress such entry of dirt, dust, and the lubricant between the air bearing surfaces 17a, 19a, 18a, and 20a of the head slider 15 and the surface of the magnetic disk 5.

Here, FIG. 5 to FIG. 7 are views of simulations of the paths of the flow of dirt and dust when forming rails projected from the facing surface of the head slider and making the contours of the side facing the flow F at the peripheries of these rails curves having shapes different from each other. Further, FIG. 8 is a view of a simulation of the path of the flow of dirt and dust when making the contours of the side facing the flow F at the peripheries of the rails formed on the facing surface of the head slider basically straight lines having an orientation cutting across the direction of flow F and forming only the edge portions by smooth curves. Note that the flow lines FL of the dirt and dust shown in FIG. 5 to FIG. 8 indicate that the amount of the flow of dirt and dust is large in a region where the density of the flow lines FL is high and the amount of the flow of dirt and dust is small in a region where the density is low.

A rail RL1 is formed on the facing surface of the head slider shown in FIG. 5. The contour of the rail RL1 at the side facing the flow F is comprised by part of an ellipse having a long axis in an orientation cutting across the direction of flow F.

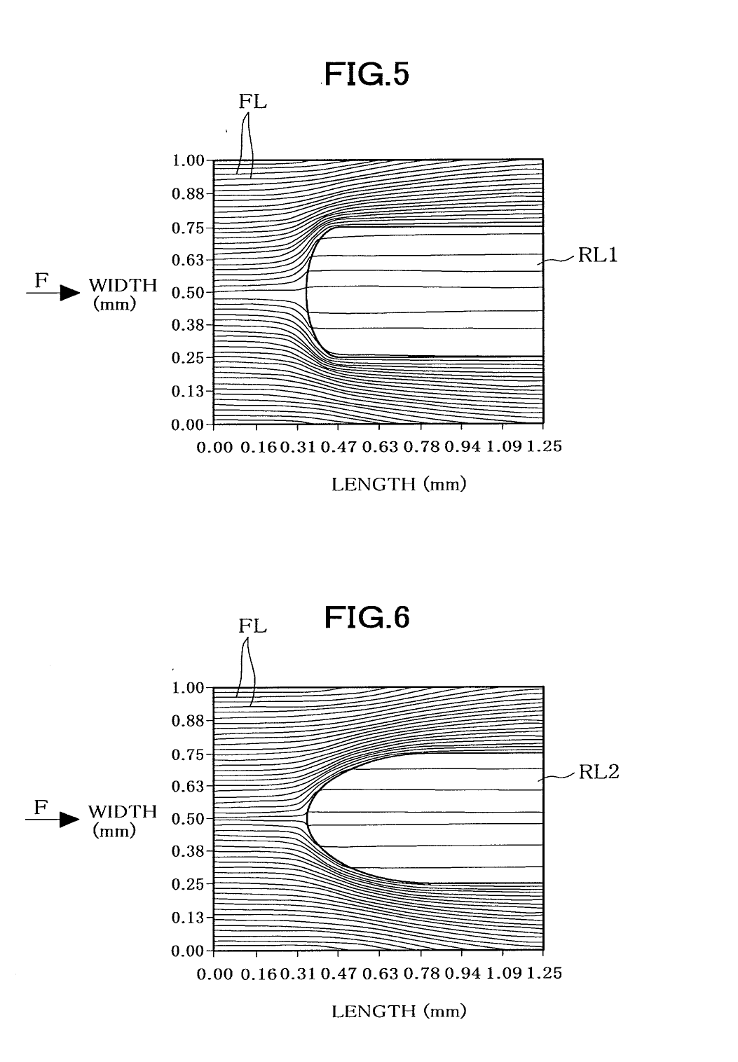

A rail RL2 is formed on the facing surface of the head slider shown in FIG. 6. The contour of the rail RL2 at the side facing the flow F is comprised by part of an ellipse having a long axis along the direction of flow F.

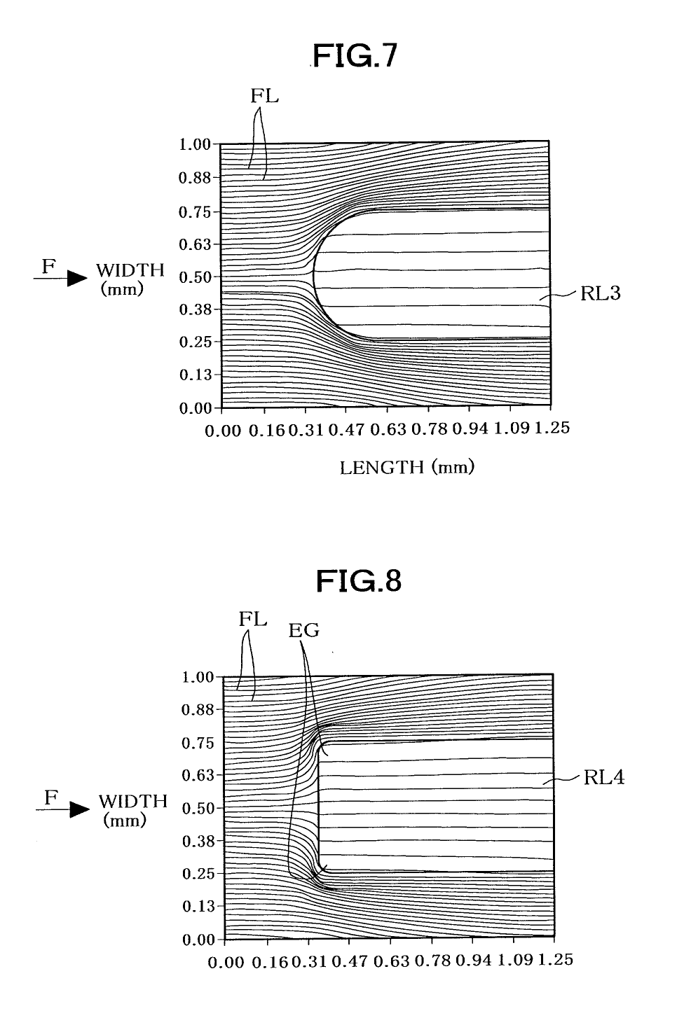

A rail RL3 is formed on the facing surface of the head slider shown in FIG. 7. The contour of the rail RL3 at the side facing the flow F is comprised by an arc.

A rail RL4 is formed on the facing surface of the head slider shown in FIG. 8. The contour of the rail RL4 at the side facing the flow F is basically comprised by a straight line having an orientation cutting across the direction of flow F. Only the edge portions EG are rounded.

Further, in order to make the lifting forces acting upon the rails R1 to R4 from the air flow the same, the rails R1 to R4 are given same rail widths and rail lengths.

When comparing FIG. 5 to FIG. 7 with FIG. 8, it is seen that the amounts of the dirt and dust riding on the rails R1, R2, and R3 having curved contours of the portions facing the flow F are smaller than that of the rail R4 having the basically straight contour of the portion facing the flow F.

Namely, when the contours of the portions facing the flow F are comprised by curves, most of the dirt and dust about to enter toward the rails R1, R2, and R3 are pushed aside to the two sides of the rails R1, R2, and R3 due to the action of the curved peripheries of the rails R1, R2 and R3 facing the direction of flow F, so the amounts of the dirt and dust riding on the rails R1, R2, and R3 are small.

Further, when comparing the rails R1, R2, and R3, it is seen that the amount of the entering dirt and dust is the smallest in the rail R2 having a contour comprised by part of an ellipse having a long axis parallel to the direction of flow F. Namely, from the viewpoint of suppressing the amount of the entering dirt and dust, preferably the contour of the portion of the rail facing the flow F is comprised by part of an ellipse having a long axis parallel to the direction of flow F.

However, by forming the rails so that the contours of the portions facing the flow F become curves convex with respect to the flow F, the effect of suppressing the amount of the entering dirt and dust can be sufficiently obtained.

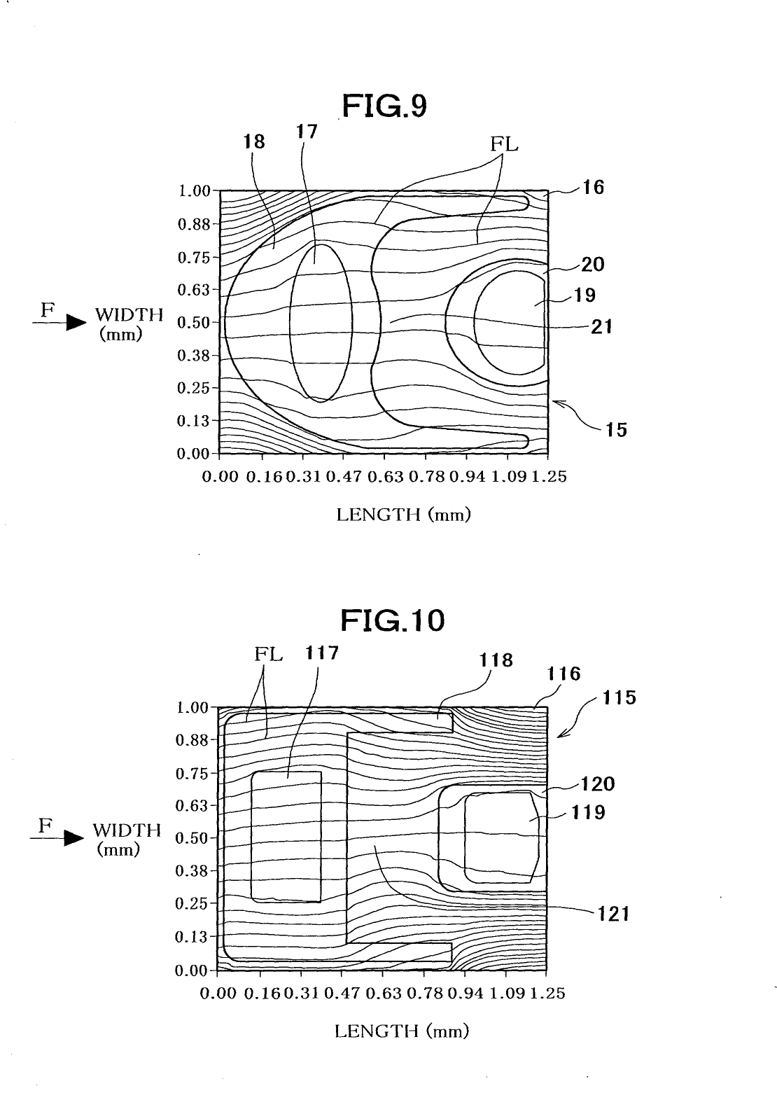

FIG. 9 is a view of a simulation of the path of the dirt and dust flowing to the facing surface 16 at the head slider 15 shown in FIG. 3 and FIG. 4. Further, FIG. 10 is a view of a simulation of the path of the dirt and dust flowing to the facing surface 116 of the head slider shown in FIG. 18 and FIG. 19.

When comparing FIG. 9 and FIG. 10, it is seen that the amount of the dirt and dust flowing to the air bearing surfaces of the rails 17 and 19 and the steps 18 and 20 is very small in the head slider 15 shown in FIG. 9. This is because, as explained by referring to FIG. 5 to FIG. 7, the peripheries of the rails 17 and 19 and the steps 18 and 20 facing the flow F are comprised by curves convex with respect to the flow F.

Further, since the rail 17 and the step 18 are upstream of the direction of flow F of the negative pressure cavity 21 of the head slider 15, the amount of the dirt and dust flowing to the negative pressure cavity 21 becomes much smaller than the amount of the dirt and dust flowing into the negative pressure cavity 121 of the head slider 115 shown in FIG. 10.

For this reason, a negative pressure is generated in the negative pressure cavity 21. Therefore, when dirt and dust enter, the dirt and dust easily accumulate at this negative pressure cavity 21, but the amount of the dirt and dust entering the negative pressure cavities 21 can be suppressed, so the amount of accumulated dirt and dust can be suppressed.

As described above, according to the present embodiment, by forming the peripheries of the rails and the steps formed on the facing surface of the head slider 15 facing the flow F by curves convex with respect to the flow F, dirt and dust can be inhibited from flowing to the rails and the steps, and the possibility of the dirt and dust remaining on the rails and the steps and exerting an adverse influence upon the flying action becomes low. For this reason, a head slider resistant to dirt and dust can be designed.

Further, design parameters such as the magnitudes of the long axes and short axes in the elliptical shapes of the rails and the steps or the radius of the arcs cannot be unilaterally determined since the optimum parameters are selected from drive conditions of the magnetic disk or head slider flying characteristics, but no matter what parameters are selected, resistance to dirt and dust can be reliably improved.

Further, by arranging a single rail 17 upstream of flow F with respect to the negative pressure cavity 21, accumulation of dirt and dust in the negative pressure cavity 21 due to the negative pressure of the negative pressure cavity 21 can be suppressed.

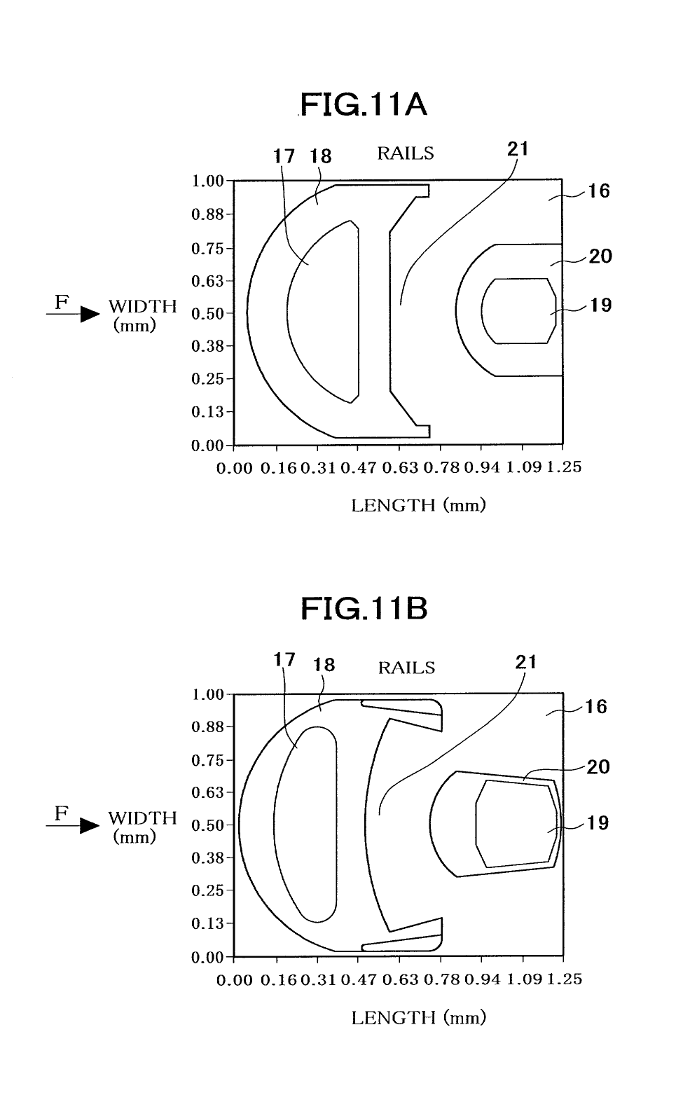

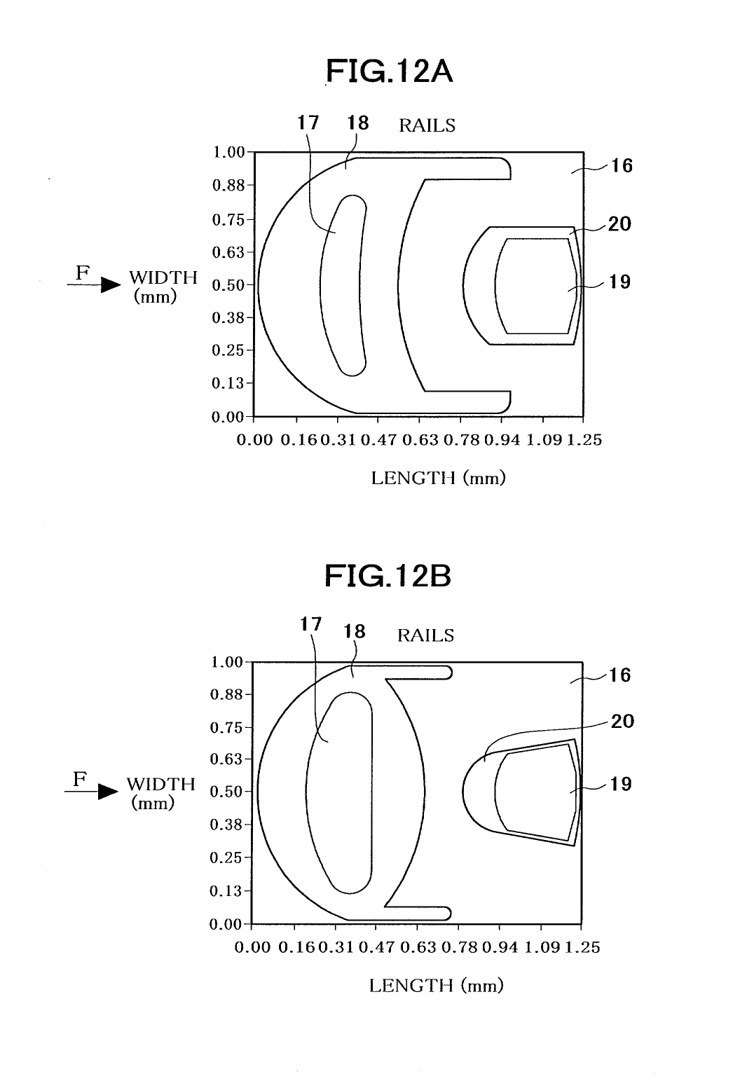

Note that, in the configuration of the head slider 15 according to the embodiment, for example, as shown in FIG. 11 and FIG. 12, various modifications matching with usage conditions of the head slider 15 are possible, but the contours of the peripheries of the rails 17 and 19 and the steps 18 and 20 facing the air flow F are made curves convex with respect to the air flow F.

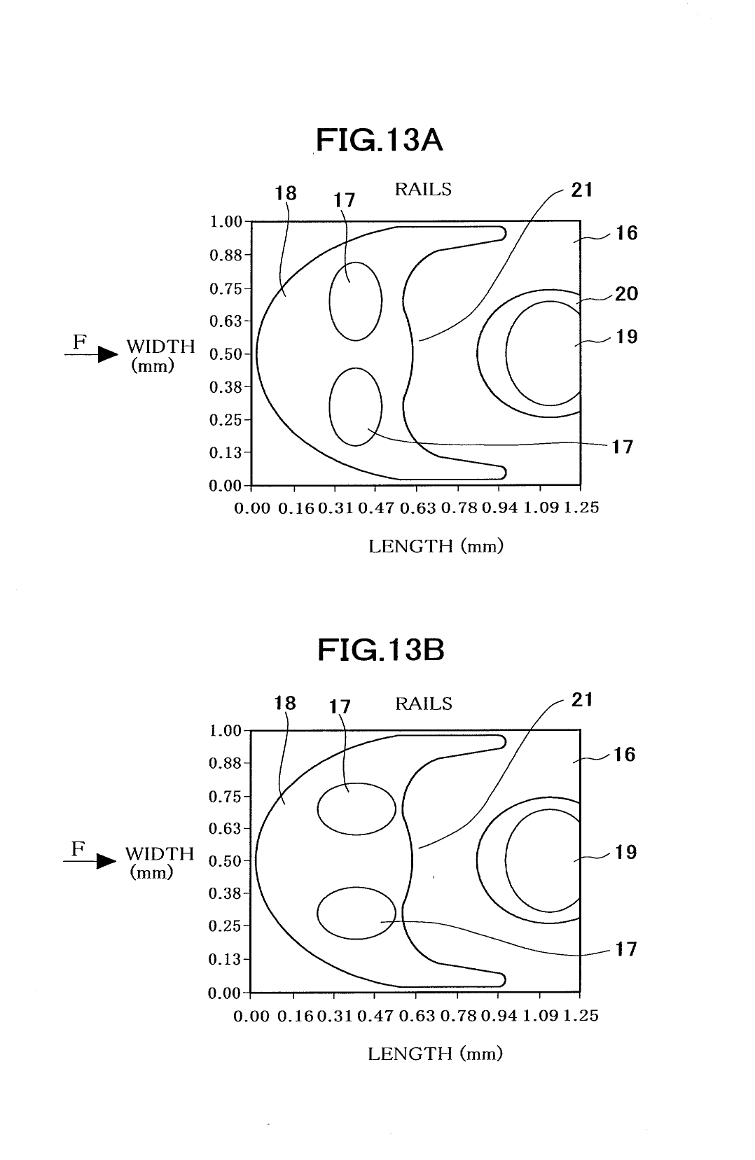

Further, when it is not necessary to consider the dirt and dust remaining in the negative pressure cavity 21, for example, as shown in FIG. 13, it is also possible to form two rails 17 upstream of the negative pressure cavity 21 of the head slider 15 at symmetric positions about the center line along the direction of flow F of the head slider 15.

The contour of the rail 17 is made an ellipse having a long axis of an orientation cutting across the direction of flow F in the case of FIG. 11A or made an ellipse having a long axis along the direction of flow F in the case of FIG. 11B. By making the contour of the rail 17 by a curve in this way, deposition of dirt and dust to the air bearing surface of the rail 17 can be suppressed.

### Second Embodiment

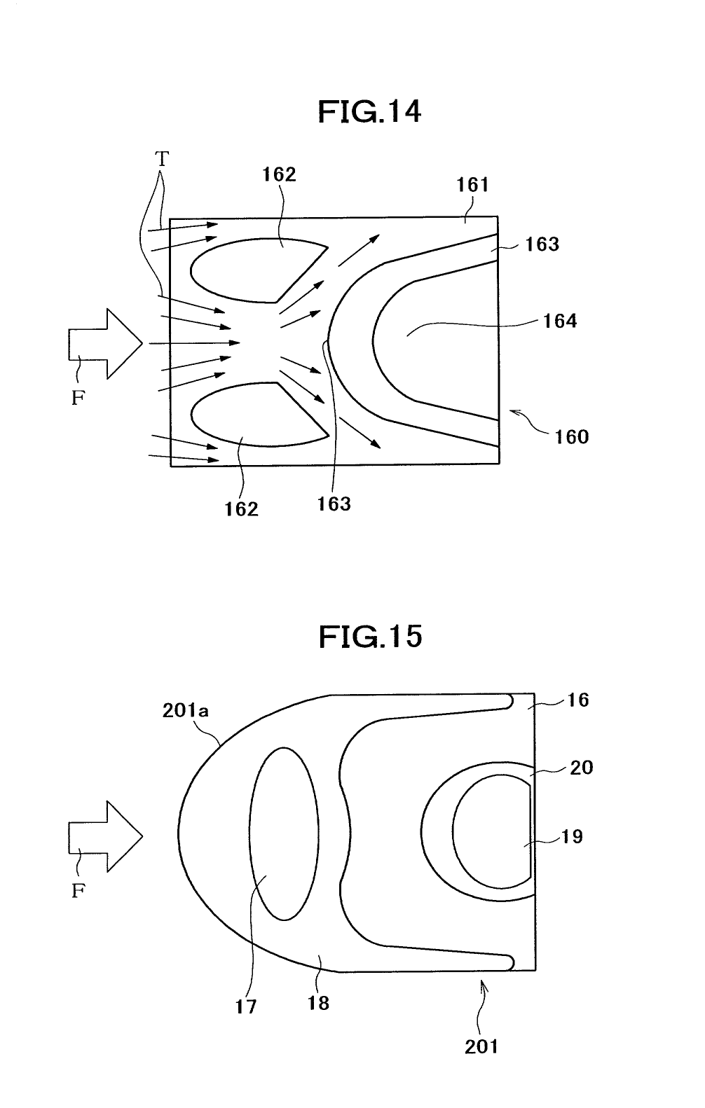

FIG. 14 is a view of the configuration of the facing surface of a head slider according to a second embodiment of the present invention.

A facing surface 161 of a head slider 160 shown in FIG. 14 is rectangular in shape. At the leading side in the direction of air flow F of this facing surface 161, rails 162 projected from the facing surface 161 are formed at symmetric positions about the center line of the head slider 160 along the direction of air flow F.

These two rails 162 have air bearing surfaces projected from the facing surface 161 by a predetermined amount. These air bearing surfaces receive a lifting force from the air flow F.

Further, downstream of the two rails 162 along the direction of flow F, a rail 163 for forming a negative pressure cavity 164 is formed symmetrically about the center line of the head slider 160 along the direction of air flow F.

The rail 163 has an air bearing surface having the same height as that of two rails 162. This air bearing surface receives a lifting force from the air flow F.

Further, the contours of the portions facing the flow F at the peripheries of above two rails 162 and the rail 163 are curves convex with respect to the flow F.

Arrows T shown in FIG. 14 indicate the path of the flow of the dirt and dust entering from the direction of flow F.

As seen from FIG. 14, since the contours of the peripheries of the two rails 162 facing the air flow F curves convex with respect to the air flow F, the dirt and dust entering from the direction of flow F flow avoiding the two rails 162.

However, since a flow path of the dirt and dust is formed between the two rails 162, the dirt and dust passing between the two rails 162 try to enter into the negative pressure cavity 164 formed at the trailing end of the rail 163.

At this time, since the contour of the periphery of the rail 163 facing the air flow F is a curve convex with respect to the air flow F, the dirt and dust heading toward the periphery of the rail 163 facing the air flow F flow directed toward the two sides of the rail 163. Therefore, the entry into the negative pressure cavity 164 is suppressed.

Accordingly, even if forming two rails 162 at the leading side of the air of the facing surface 161 of the head slider 160, the dirt and dust are attracted to the negative pressure cavity 164 formed downstream of the two rails 162 by the negative pressure, so the accumulation of the dirt and dust in the negative pressure cavity 164 can be suppressed.

### Third Embodiment

FIG. 15 is a view of the configuration of the facing surface of a head slider according to a third embodiment of the present invention.

On the facing surface 16 of a head slider 201 shown in FIG. 15, similar to the head slider 15 according to the first embodiment, rails 17 and 19 and steps 18 and 20 are formed. This is the same configuration as that of the head slider 15 according to the first embodiment.

The difference of the head slider 201 according to the present embodiment from the head slider 15 resides in that the contour of the portion facing the air flow F at the periphery 201a of the head slider 201 is a curve convex with respect to the air flow F.

Accordingly, the side faces of the periphery 201a of the head slider 201 facing the flow F form bent curved surfaces.

By making the contour of the head slider 201 per se a curve in this way, the dirt and dust entering from the direction of flow F toward the head slider 201 are pushed aside to the sides of the head slider 201 by an action similar to that explained by referring to FIG. 5 to FIG. 7.

Namely, the dirt and dust are inhibited from entering into the step 18 in comparison with the case where the facing surface 16 is upstream of the step 18 in the direction of air flow F.

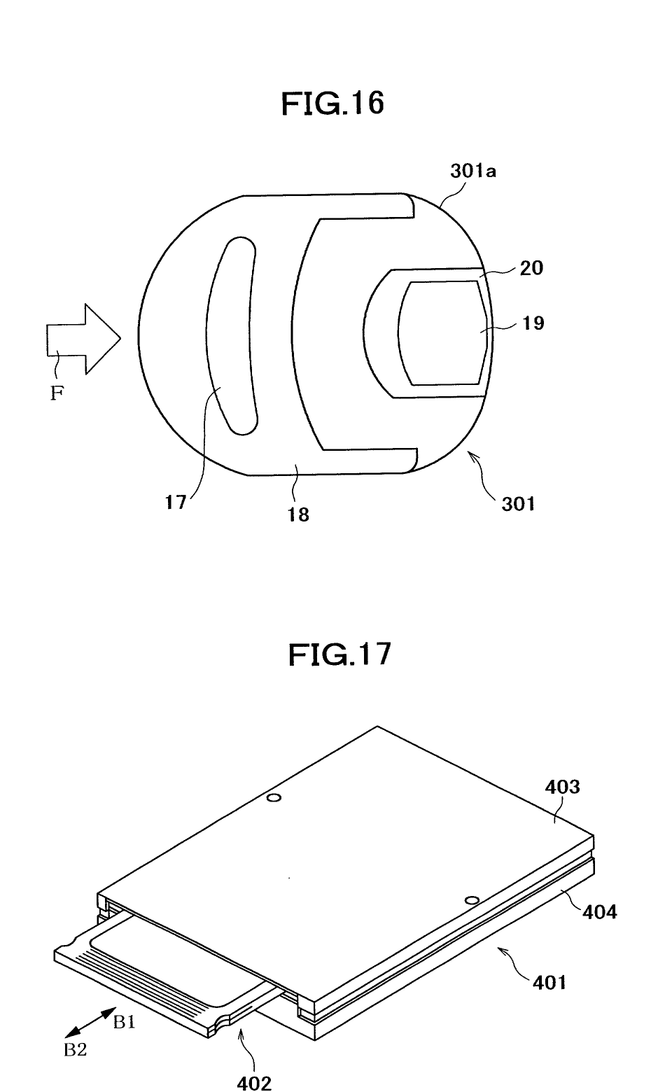

Further, for example, as in a head slider 301 shown in FIG. 16, it is also possible to make the contour of a periphery 301a of the head slider 301 substantially an ellipse.

While the invention has been described with reference to specific embodiment chosen for purpose of illustration, it should be apparent that numerous modifications could be made thereto by those skilled in the art without departing from the basic concept and scope of the invention.

In the first embodiment, the explanation was made of the case of a fixed type magnetic disk drive having the magnetic disk 5 fixed to the spindle motor 4 serving as the rotation driving means as the disk drive provided with the head slider 15, but the present invention can also be applied to a so-called removable type magnetic disk drive 401 wherein, for example, as shown in FIG. 17, a disk cartridge 402 accommodating the magnetic disk is loaded into or ejected from the drive.

Note that the magnetic disk drive 401 has an internal configuration similar to the magnetic disk drive shown in FIG. 1. In addition, it is provided with a mechanism which, when a disk cartridge 402 is inserted in the direction indicated by an arrow B1 of FIG. 17, makes a cartridge holder 403 holding the disk cartridge 402 descend in a direction toward a chassis 404 so that the cartridge holder 403 chucks the magnetic disk accommodated in the disk cartridge 402 on a spindle motor built in the drive.

In such a removable type magnetic disk drive 401, the dirt and dust easily enter the internal portion of the device from the outside. By applying the head slider of the present invention, resistance to dirt and dust can be greatly improved.

Further, in the above embodiments, the explanation was made of the case of a magnetic disk drive as the disk drive, but the present invention can also be applied to for example a magneto-optic disk drive and optical disk drive.

Summarizing the effects of the invention, according to the present invention, even in the case where vibration or shock is applied from the outside, contact between sharp edges of the head slider and the recording medium surface and the resultant scratching of the recording medium surface can be avoided, so the possibility of scratching the recording medium surface is greatly lowered. Accordingly, a disk drive resistant to vibration or shock can be realized.

Further, by making the contours of the peripheries of the rails curves convex with respect to the air flow, the dirt and dust or lubricant are inhibited from flowing on the rails of the head slider and therefore a stable flying action can be continued.

What is claimed is:

1. A head slider comprising:
a slider having a rail formed on a facing surface arranged facing a rotating recording medium surface and receiving a lifting force from an air flow between said recording medium surface and said facing surface, and
a head performing at least one of reproduction and recording of data, wherein
the contour of said rail at the side facing said air flow is a curve convex with respect to said air flow.

2. A head slider as set forth in claim 1, wherein further comprising a step provided with the circumference of said rail and receiving a lifting force from said air flow, and the contour of said step at the side facing said air flow is a curve convex with respect to said air flow.

3. A head slider as set forth in claim 1, wherein the contour of said slider is a curve convex with respect to said air flow.

4. A head slider as set forth in claim 1, wherein
the contour of said rail at the side facing said air flow is arc.

5. A head slider as set forth in claim 1, wherein
the contour of said rail at the side facing said air flow is part of an ellipse.

6. A head slider as set forth in claim 1, wherein
the contour of said rail is completely curved.

7. A head slider as set forth claim 2, wherein
the contour of said step at the side facing said air flow is arc.

8. A head slider as set forth claim 2, wherein
the contour of said step at the side facing said air flow is part of an ellipse.

9. A head slider as set forth claim 2, wherein
the contour of said step is completely curved.

10. A head slider as set forth claim 3, wherein
the contour of said slider at the side facing said air flow is arc.

11. A head slider as set forth claim 3, wherein
the contour of said slider at the side facing said air flow is part of an ellipse.

12. A head slider as set forth claim 3, wherein
the contour of said slider is completely curved.

13. A head slider as set forth claim 1, wherein
further comprising a negative pressure cavity formed at the down-streaming side to said rail on said facing surface and receiving a suction force opposite to said lifting force.

14. A head slider as set forth claim 2, wherein further comprising a negative pressure cavity formed at the down-streaming side to said step on said facing surface and receiving a suction force opposite to said lifting force.

15. A head slider as set forth claim 14, wherein
said rail is disposed at the up-streaming side to said negative pressure cavity.

16. A head slider comprising:
a slider having a rail formed on a facing surface arranges facing a rotating recording medium surface and receiving a lifting force from an air flow between said recording medium surface and said facing surface, and
a head performing at least one of reproduction and recording of data, wherein
the contour of said slider at the side facing said air flow is a curve convex with respect to said air flow.

17. A head slider as set forth claim 16, wherein:
the contour of said rail at the side facing said air flow is a curve convex with respect to said air flow.

18. A head slider as set forth in claim 17, wherein further comprising a step provided with the circumference of said rail and receiving a lifting force from said air flow, wherein the contour of said step at the side facing said air flow is a curve convex with respect to said air flow.

19. A disk drive comprising:
a rotation means for rotating a disk-like recording medium,
a slider having a rail formed on a facing surface arranged facing the rotating recording medium surface and receiving a lifting force from air flow between said recording medium surface and said facing surface, and
a head mounted in said slider and performing at least one of reproduction and recording of data,
wherein the contour of said rail at the side facing said air flow is curve convex with respect to said air flow.

20. A disk drive as set forth claim 19, wherein said recording medium is freely insertable into and ejectable from said rotation means.

21. A disk drive as set forth claim 19, wherein further comprising a step formed with the circumference of said rail and receiving a lifting force from said air flow, and
the contour of said step at the side having said air flow is curve convex with respect to said air flow.

22. A head slider as set forth in claim 1, wherein the contour of said slider is a curve convex with respect to said air flow.

23. A disk drive comprising:
a rotation means for rotating a disk-like recording medium,
a slider having a rail formed on a facing surface arranged facing the rotating recording medium surface and receiving a lifting force from air flow between said recording medium surface and said facing surface and
a head mounted in said slider and performing at least one of reproduction and recording data,
wherein the contour of said slider at the side facing said air flow is curve convex with respect to said air flow.

24. A disk drive as set forth claim 23, wherein said recording medium is freely insertable into and ejectable from said rotation means.

25. A disk drive as set forth claim 23, wherein
the contour of said rail at the side facing said air flow is a curve convex with respect to said air flow.

26. A head slider as set forth in claim 23, wherein further comprising a step provided with the circumference of said rail and receiving a lifting force from said air flow, and the contour of said step at the side facing said air flow is a curve convex with respect to said air flow.
